(19) United States
(12) Patent Application Publication
(10) Pub. No.: US 2006/0218813 A1
(43) Pub. Date: Oct. 5, 2006

(54) Dehydrating device

(76) Inventor: Hsiang-Lin Hsieh, Jhongli City (TW)

Correspondence Address: CHARLES E. BAXLEY, ESQ., 90 JOHN STREET, THIRD FLOOR, NEW YORK, NY, 10038, US

(21) Appl. No.: 11/097,893

(22) Filed: Apr. 1, 2005

(51) Int. Cl. F26B 19/00

(52) U.S. Cl. 34/228; 198/603; 34/226

(57) ABSTRACT

A dehydrating device includes a hollow body a plurality of conveyors received in the body and the conveyors are arranged from a higher position to a lower position so that goods is fed into the body and conveyed by the conveyors. At least one heat source is connected to the body and provides hot air flows which flows in a direction that is opposite to a direction of the conveyors so as to evenly dehydrate the goods on the conveyors.

### FIELD OF THE INVENTION

The present invention relates to a dehydrating device which provides hot air flows to dehydrate goods on the conveyer which moves the goods in opposite direction to the direction of the hot air flows

### BACKGROUND OF THE INVENTION

A conventional dehydrating device generally includes an oven in which the goods to be dehydrated in received, a heat source is used to directly heat the oven so as to increase temperature of the oven to reduce the humidity of the goods. Nevertheless, the heat source applies high temperature at a center portion of the oven and the rest of the area of the oven is gradually heated so that the heat cannot evenly be applied to the goods. If the temperature is too high, the outside of the goods burns before the inside of the goods is dehydrated. If the temperature is too low, it takes a long period of time to completely dehydrate the goods.

The present invention intends to provide a dehydrating device that evenly dehydrates goods within a short period of time.

### SUMMARY OF THE INVENTION

The present invention relates to a dehydrating device that comprises a hollow body having an inlet, an outlet and a ventilation hole. A plurality of conveyors are received in the body and arranged from a higher position to a lower position. The conveyor is located at the higher position has a first end located beneath the inlet so that goods enters the body from the inlet and conveyed by the conveyors and exits the body from the outlet. At least one heat source is connected to the body and provides hot air flows which flows in a direction that is opposite to a direction of the conveyors.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the dehydrating device of the present invention.

### DETAILED DESCRIPTION OF THE PREFERRED EMBODIMENT

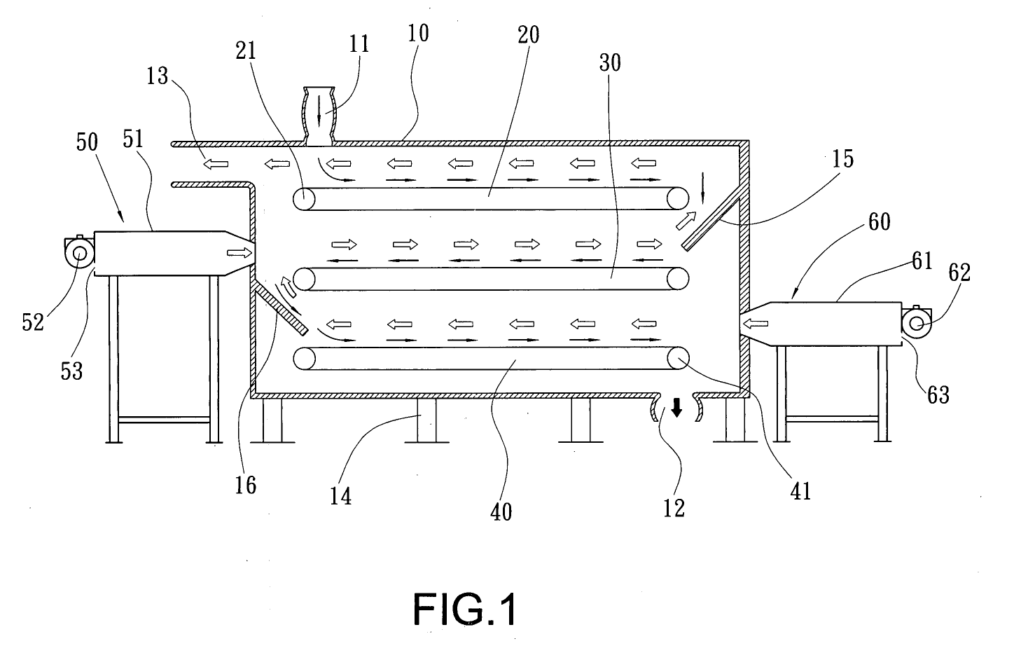

Referring to FIG. 1, the dehydrating device of the present invention comprises a hollow body 10 which has an inlet 11 defined in a top of the body 10, an outlet 12 defined through a bottom of the body 10, and a ventilation hole 13 which is defined through an end of the body 10. The inlet 11 allows goods to be dehydrated to enter the body 10 and the outlet 12 allows the dehydrated goods to exit from the body 10. The ventilation hole 13 allows hot air flows to exit from the body 10.

Three conveyors 20, 30, 40 are received in the body 10 and arranged in parallel from a higher position to a lower position. The conveyor 20 located at the higher position 20 has a first end 21 located beneath the inlet 11 so that the goods directly drops on the conveyor 20. The conveyors 40 located on the lower position has a first end 41 located above the outlet 12 so that the dehydrated goods drop out from the outlet 12.

Two guide boards 15, 16 are connected to two opposite insides of the body 10, wherein the guide board 15 is located between a second end of the conveyor 20 and a first end of the conveyor 30 so that the goods from the conveyor 20 flips and drops on the conveyor 30. The guide board 16 is located between a second end of the conveyor 30 and a second end of the conveyor 40 so that the goods from the conveyor 30 flips and drops on the conveyor 40.

Two heat sources 50, 60 are connected to the body 10 and provide hot air flows into the body 10 to dehydrate the goods. Each of the heat sources 50, 60 includes an energy transferring member 51/61 which has one end connected to a burner 52/62 and the other end of the energy transferring member 51/61 is in communication with the body 10. The hot air flows flow in a direction that is opposite to a direction of the conveyors 20, 30, 40. Each of the energy transferring members 51, 61 includes a valve 53/63 at a lower position thereof so as to adjust the volume of air entering the energy transferring members 51, 61. The two heat sources 50, 60 are set to provide the hot air flows with higher temperature at the lower positions of the body 10 and lower temperature at the higher position of the body 10. By the dehydrating device, the goods can be dehydrated within a short period of time.

While we have shown and described the embodiment in accordance with the present invention, it should be clear to those skilled in the art that further embodiments may be made without departing from the scope of the present invention.

What is claimed is:

1. A dehydrating device comprising:
a hollow body having an inlet, an outlet and a ventilation hole, the inlet adapted to allow goods to enter the body and the outlet adapted to allow the goods to exit from the body;
a plurality of conveyors received in the body and arranged from a higher position to a lower position, the conveyor located at the higher position having a first end located beneath the inlet, the conveyors located on the lower position having a first end located above the outlet, and
at least one heat source connected to the body and providing hot air flows which flows in a direction that is opposite to a direction of the conveyors.

2. The device as claimed in claim 1, wherein the inlet is located at a top of the body and the outlet is located at a bottom of the body.

3. The device as claimed in claim 1, wherein at least one guide board is connected to an inside of the body and located between the conveyors so as to adapted to flip goods dropping from the conveyor of the higher position.

4. The device as claimed in claim 1, wherein the at least one heat source includes an energy transferring member which has one end connected to a burner and the other end of the energy transferring member is in communication with the body.
